(19) United States
(12) Patent Application Publication
(10) Pub. No.: US 2022/0329644 A1
(43) Pub. Date: Oct. 13, 2022

(54) REAL-TIME SYSTEM AND METHOD FOR SILENT PARTY HOSTING AND STREAMING

(71) Applicant: Patricia Kelly Marsh, Atlanta, GA (US)

(72) Inventor: Patricia Kelly Marsh, Atlanta, GA (US)

(21) Appl. No.: 17/206,986

(22) Filed: Mar. 19, 2021

Related U.S. Application Data
(60) Provisional application No. 63/013,106, filed on Apr. 21, 2020.
(60) Provisional application No. 63/014,610, filed on Jun. 29, 2020.

(51) Int. Cl. H04L 65/611; H04L 65/401

(52) U.S. Cl. CPC H04L 65/611; H04L 65/401

(57) ABSTRACT

The system and techniques disclose as a software platform, including computer software applications (apps) and a backend system that can be used to provide hosting and streaming of a silent party. The system allows a host to set up a silent party, specifically selecting the music that is played during the silent party and designating virtual “rooms” where different genres of music can be played simultaneously. Further, the system streams real-time content, including music, for the silent party simultaneously to different silent party attendees at various remote locations. The silent party attendees access the real-time stream, using their respective computer devices and headphones, so that the music can still be enjoyed “silently”. Accordingly, the system allows for a unique and exciting “virtual” silent party experience that can be enjoyed by users anywhere in real-time, as if they were all physically together in the same room of a conventional silent party.

### FIELD OF DISCLOSURE

The present disclosure generally relates to real-time streaming of audio, namely music, that can be securely accessed and distributed, and more particularly, to a music streaming platform that can be used to support multiple devices listening to the same audio steam simultaneously in real-time to simulate a live music event, such as a party, concert, and the like.

### BACKGROUND OF THE DISCLOSURE

Silent parties have been growing in popularity in recent years, providing an alternative to traditional parties where music is played loudly in a large area (where party goers are gathered) which can be subject to noise ordinances, and complaints from those nearby, and even hefty fines. For instance, there are several noise ordinances that exist to protect, preserve, and promote the health, safety and welfare of citizens through the control of noise. Silent parties (also referred to as silent discos, or silent raves) are events where people dance to music listened to on wireless headphones, rather than using a speaker system. For example, in a silent party the music is broadcast via a radio transmitter with the signal being picked up by wireless headphone receivers worn by the participants. Those without the headphones hear no music, giving the effect of a room full of people dancing to silence (e.g., no music). It may be desirable to provide a software platform that can support a simulated silent party. By simulating, or hosting a virtual silent party, users can utilize their own mobile devices and headphones to “silently” listen to the music played in the silent party, while remaining in the comfort of their own home, while exercising, while on vacation, or any location that is remote from the host of the party (e.g., source of the music).

### BRIEF OVERVIEW

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are and explanatory only and are not restrictive of the disclosure, as claimed.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1A illustrates an example of a communication system in which embodiments disclosed herein may be implemented for providing a real-time silent party hosting and streaming system, according to one or more embodiments shown and described herein.

FIG. 1B illustrates an example graphical user interface displaying a mobile view of a live real-time silent party feature that may be implemented by the silent party attendee application shown in FIG. 1A, according to one or more embodiments shown and described herein.

FIG. 1C illustrates an example graphical user interface displaying a mobile view of an account upgrade feature that may be implemented by the silent party attendee application shown in FIG. 1A, according to one or more embodiments shown and described herein.

FIG. 1D illustrates an example graphical user interface displaying a mobile view of a profile data collection feature that may be implemented by the silent party attendee application shown in FIG. 1A, according to one or more embodiments shown and described herein.

FIG. 1E illustrates an example graphical user interface displaying a mobile view of a public profile feature that may be implemented by the silent party attendee application shown in FIG. 1A, according to one or more embodiments shown and described herein.

FIG. 1F illustrates an example graphical user interface displaying a mobile view of a landing deck feature that may be implemented by the silent party attendee application shown in FIG. 1A, according to one or more embodiments shown and described herein.

FIG. 1G illustrates an example graphical user interface displaying a mobile view of a ticket feature that may be implemented by the silent party attendee application shown in FIG. 1A, according to one or more embodiments shown and described herein.

FIG. 1H illustrates an example graphical user interface displaying a mobile view of a real-time silent party details feature that may be implemented by the silent party attendee application shown in FIG. 1A, according to one or more embodiments shown and described herein.

FIG. 1I illustrates an example graphical user interface displaying a web view of an archive of real-time silent parties feature that may be implemented by the silent party attendee application shown in FIG. 1A, according to one or more embodiments shown and described herein.

FIG. 1J illustrates an example graphical user interface displaying a mobile view of a search feature that may be implemented by the silent party attendee application shown in FIG. 1A, according to one or more embodiments shown and described herein.

FIG. 1K illustrates an example an example graphical user interface displaying a mobile view of a create a ShhParty feature that may be implemented by the silent party attendee application shown in FIG. 1A, according to one or more embodiments shown and described herein.

FIG. 1L illustrates an example graphical user interface displaying a mobile view of a registration/login feature that may be implemented by the silent party attendee application shown in FIG. 1A, according to one or more embodiments shown and described herein.

FIG. 1M illustrates an example graphical user interface displaying a web view of a landing deck feature that may be implemented by the silent party attendee application shown in FIG. 1A, according to one or more embodiments shown and described herein.

FIG. 1N illustrates an example graphical user interface displaying a web view of an edit room feature that may be implemented by the silent party attendee application shown in FIG. 1A, according to one or more embodiments shown and described herein.

FIG. 1O illustrates an example graphical user interface displaying a web view of a past tickets feature that may be implemented by the silent party attendee application shown in FIG. 1A, according to one or more embodiments shown and described herein.

FIG. 1P illustrates an example graphical user interface displaying a web view of a public profile feature that may be implemented by the silent party attendee application shown in FIG. 1A, according to one or more embodiments shown and described herein.

FIG. 1Q illustrates an example graphical user interface displaying a web view of a profile data collected feature that may be implemented by the silent party attendee application shown in FIG. 1A, according to one or more embodiments shown and described herein.

FIG. 1R illustrates an example graphical user interface displaying a web view of a registration/login feature that may be implemented by the silent party attendee application shown in FIG. 1A, according to one or more embodiments shown and described herein.

FIG. 1S illustrates an example graphical user interface displaying web view of a real-time silent party room details feature that may be implemented by the silent party attendee application shown in FIG. 1A, according to one or more embodiments shown and described herein.

FIG. 1T illustrates an example graphical user interface displaying a web view of a search feature that may be implemented by the silent party attendee application shown in FIG. 1A, according to one or more embodiments shown and described herein.

FIG. 1U illustrates an example graphical user interface displaying a web view of a subscription account feature that may be implemented by the silent party attendee application shown in FIG. 1A, according to one or more embodiments shown and described herein.

FIG. 1V illustrates an example graphical user interface displaying a web view of a subscription account types feature that may be implemented by the silent party attendee application shown in FIG. 1A, according to one or more embodiments shown and described herein.

FIG. 1W illustrates an example graphical user interface displaying a web view of an upcoming real-time silent party feature that may be implemented by the silent party attendee application shown in FIG. 1A, according to one or more embodiments shown and described herein.

FIG. 1X illustrates an example graphical user interface displaying a web view of an upcoming tickets feature that may be implemented by the silent party attendee application shown in FIG. 1A, according to one or more embodiments shown and described herein.

FIG. 1Y illustrates an example graphical user interface displaying a web view of an upgrade account feature that may be implemented by the silent party attendee application shown in FIG. 1A, according to one or more embodiments shown and described herein.

FIG. 2 depicts an example of a message flow between a host device (e.g., silent party host), a consumer device (e.g., silent party attendee), and the system shown in FIG. 1A related to providing a real-time hosting and streaming of a silent party, according to one or more embodiments shown and described herein.

FIG. 3 depicts an example of a method for implementing real-time hosting and streaming of a silent party, according to one or more embodiments shown and described herein.

FIG. 4 depicts an example of a computer system that may be used in implementing a device of the real-time silent party hosting and streaming system shown in FIG. 1A, according to one or more embodiments shown and described herein.

FIG. 5 depicts an example of a mobile computer system, such as a smartphone, that may be used in implementing a device of the real-time silent party hosting and streaming system shown in FIG. 1A, according to one or more embodiments shown and described herein.

### DETAILED DESCRIPTION OF THE DISCLOSURE

The present disclosure includes many aspects and features. Moreover, while many aspects and features relate to, and are described in, the context of embodiments of the present disclosure are not limited to use only in this context. The present disclosure can be understood more readily by reference to the following detailed description of the disclosure and the Examples included therein.

Before the present articles, systems, apparatuses, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed apparatuses, systems, and articles of the disclosure as well as the apparatuses themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and apparatuses of the disclosure. Thus, if there are a variety of additional steps that can be performed it is understood that each of these additional steps can be performed with any specific aspect or combination of aspects of the methods of the disclosure.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

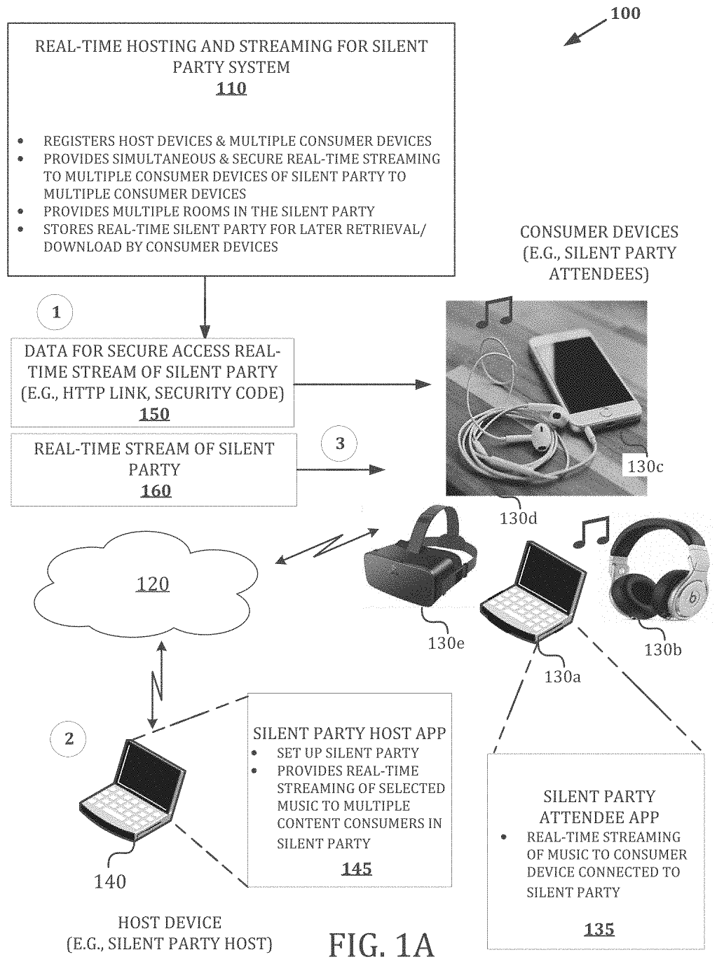

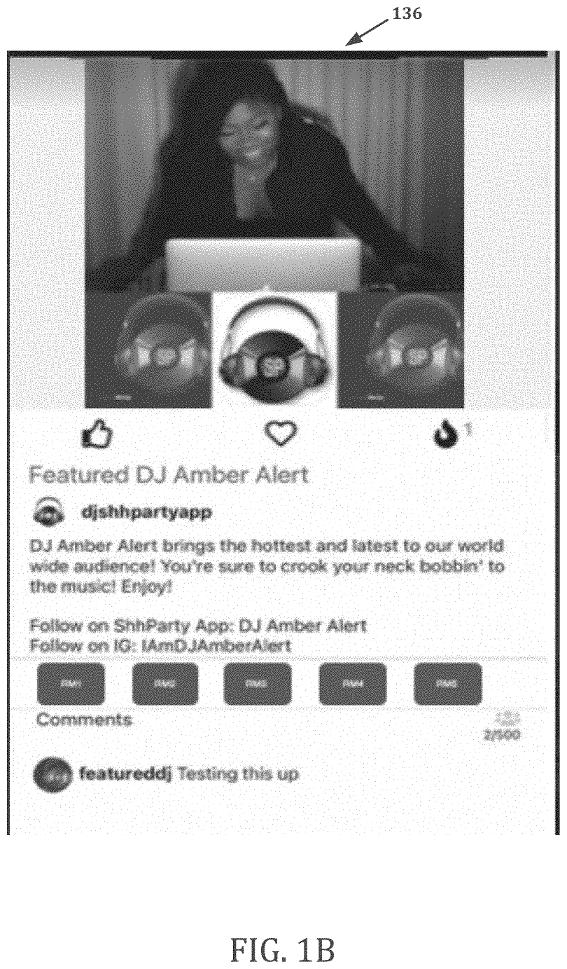

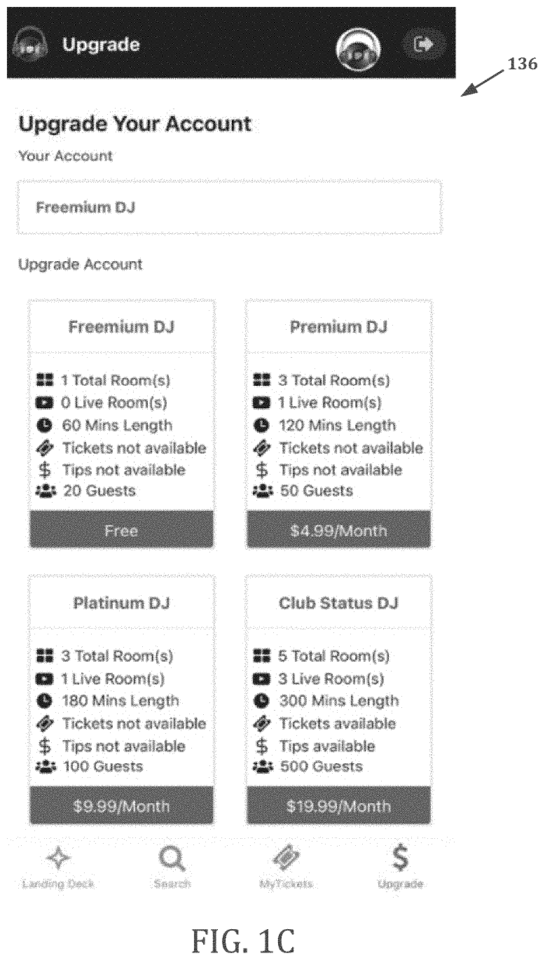

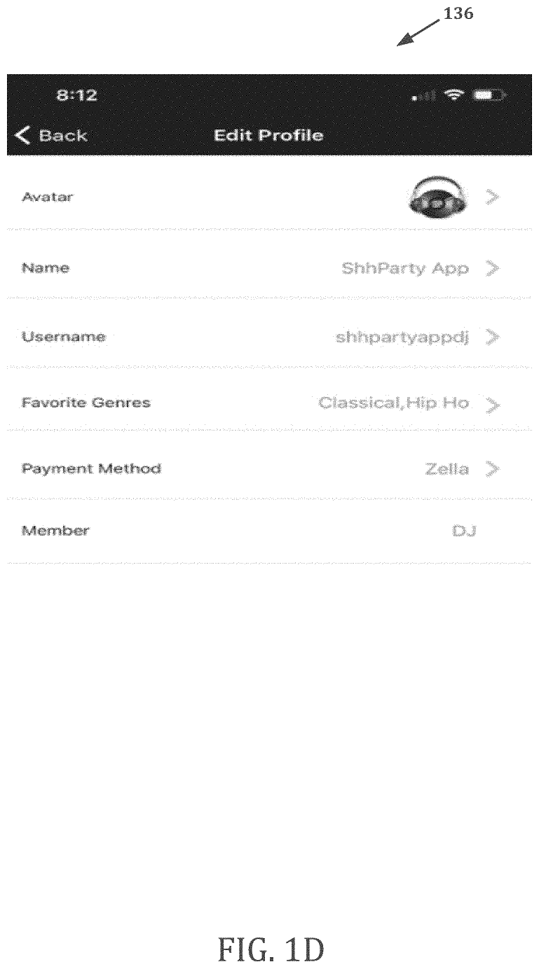

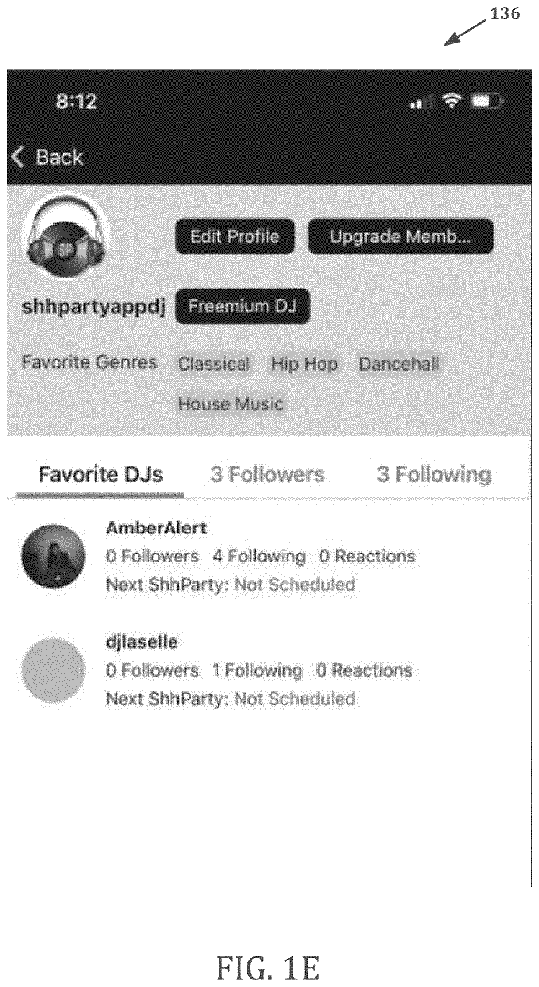

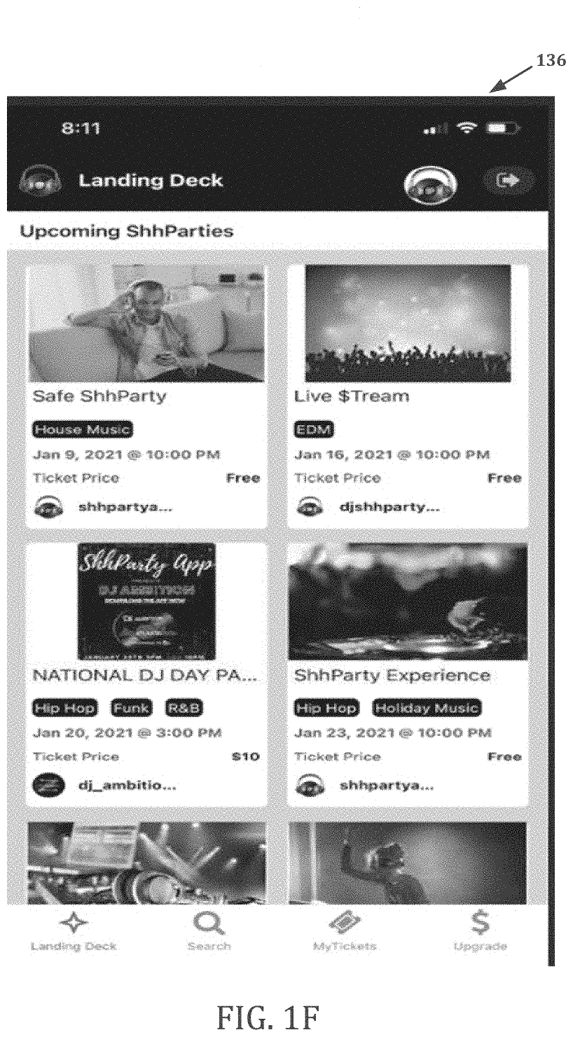

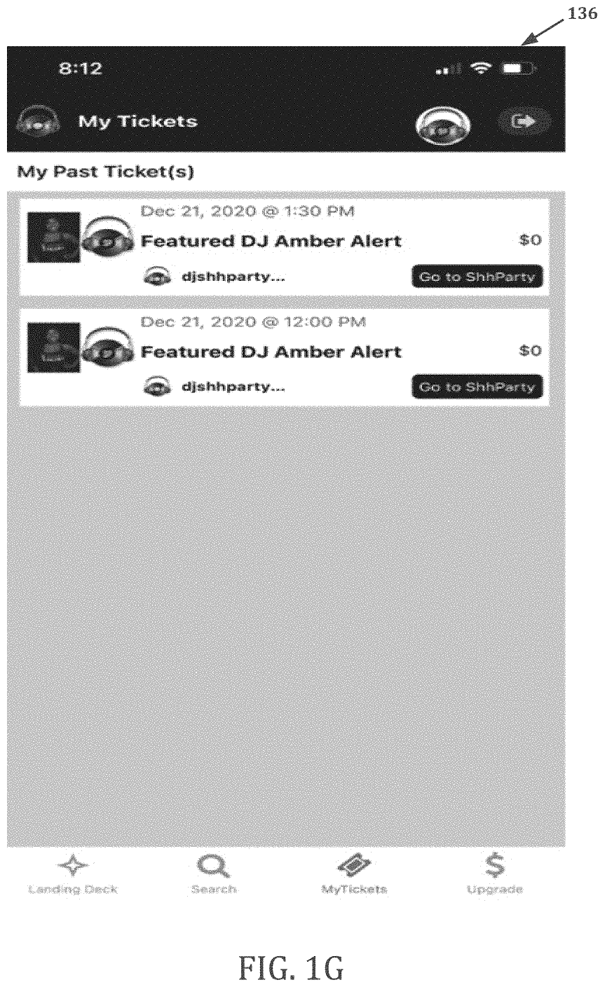

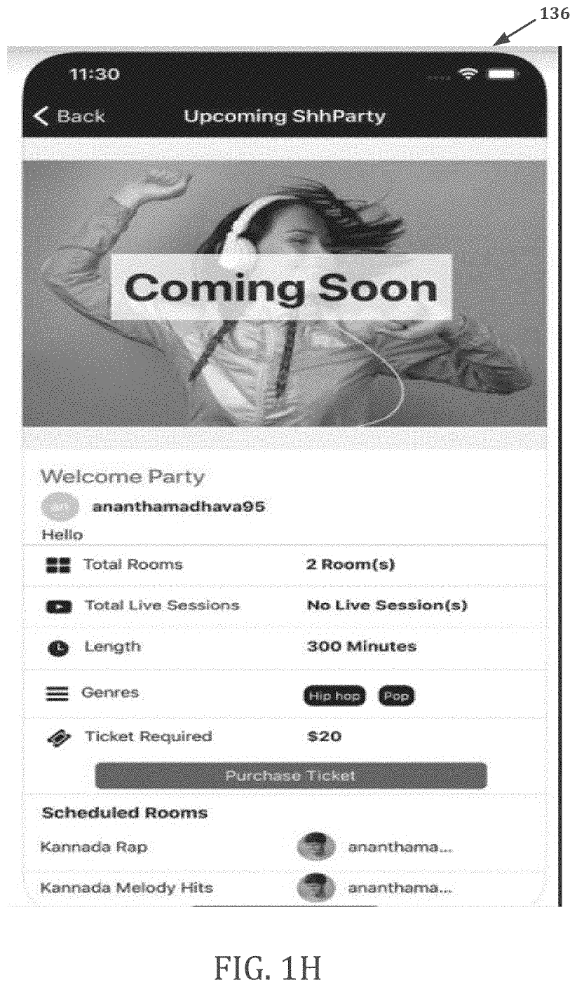

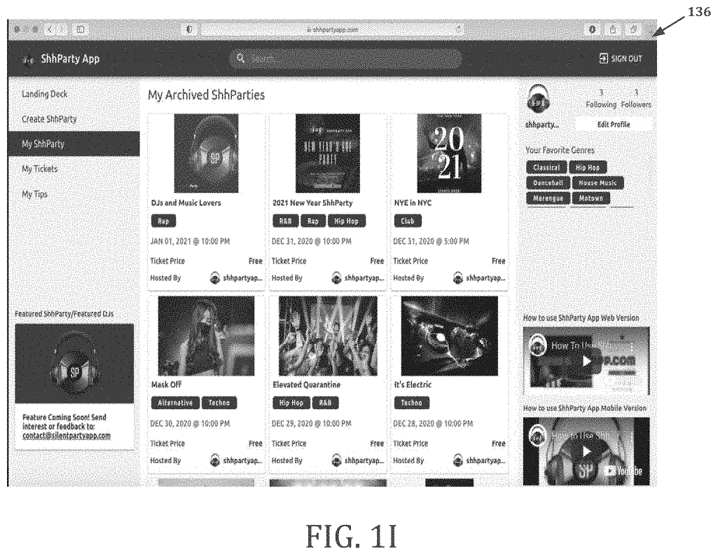

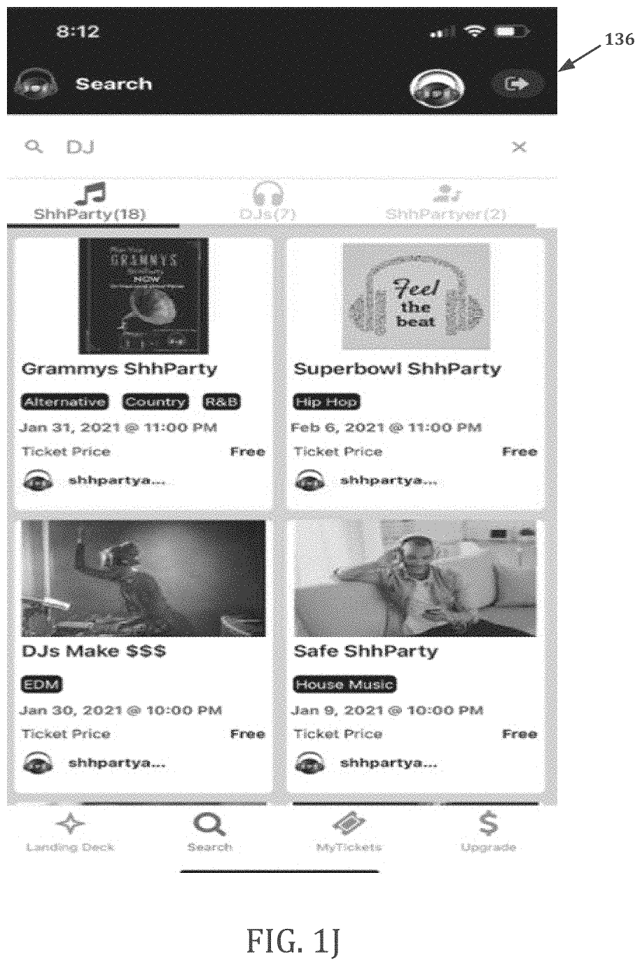

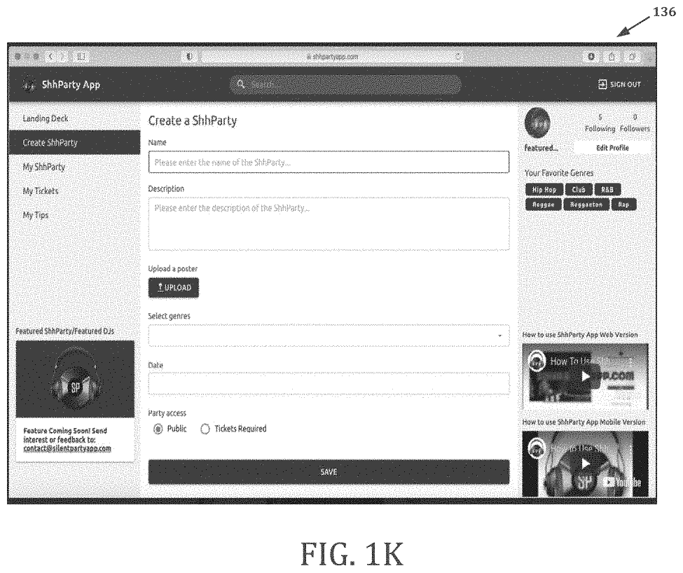

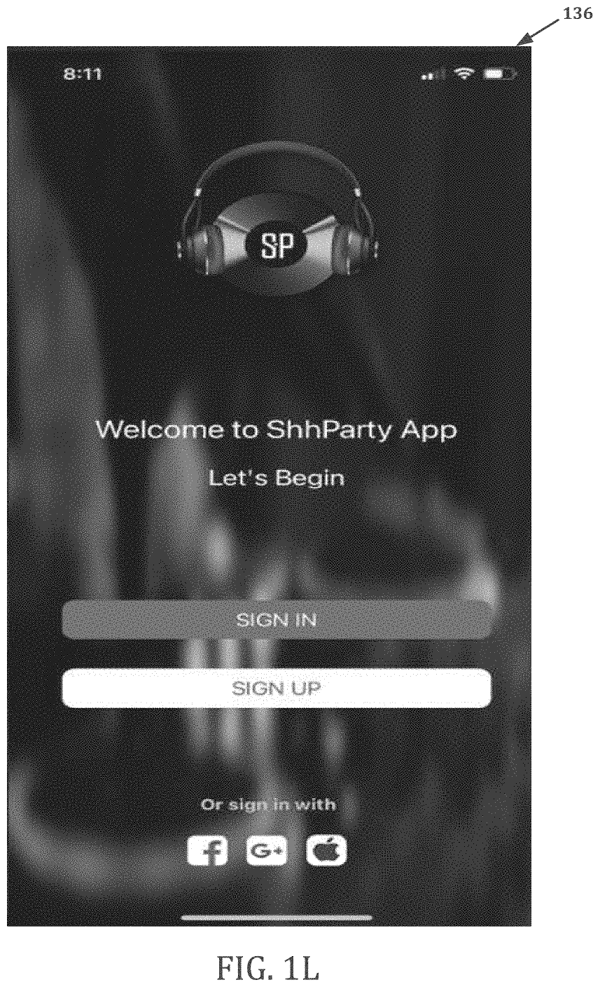

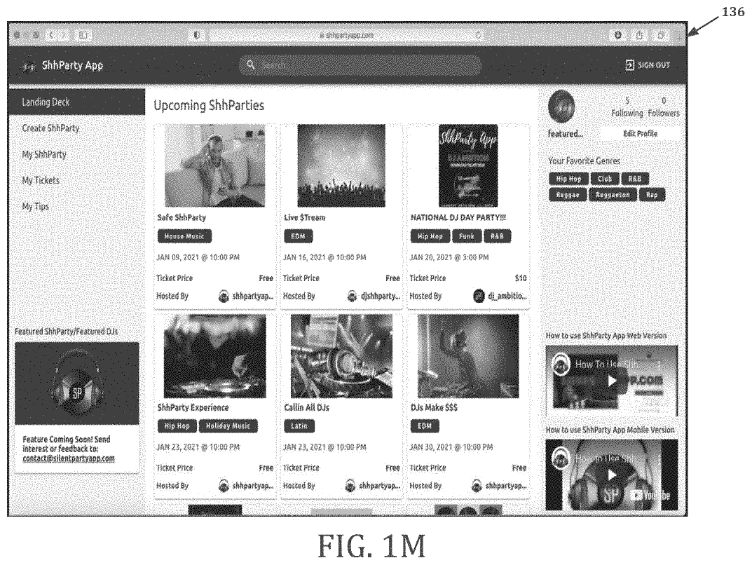

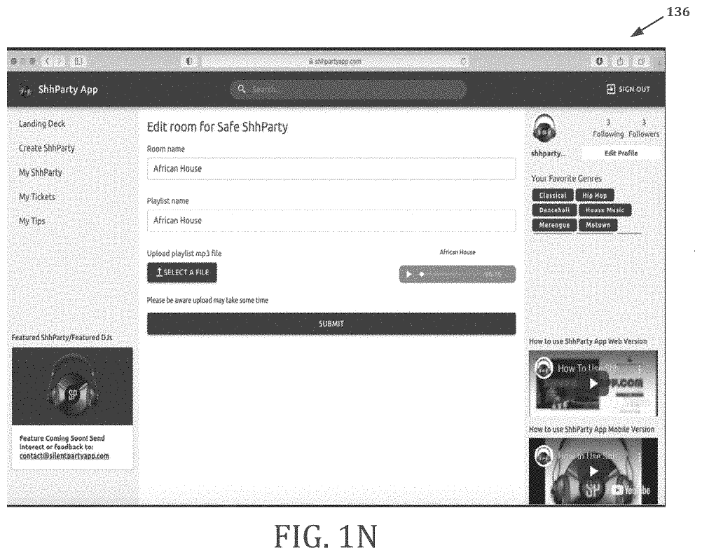

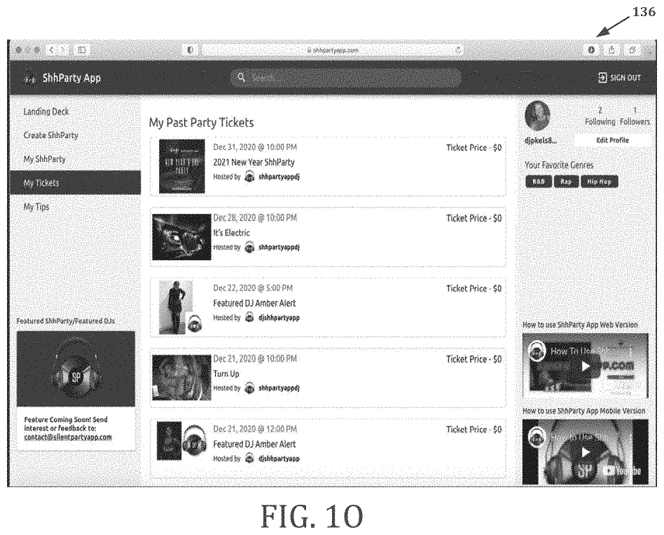

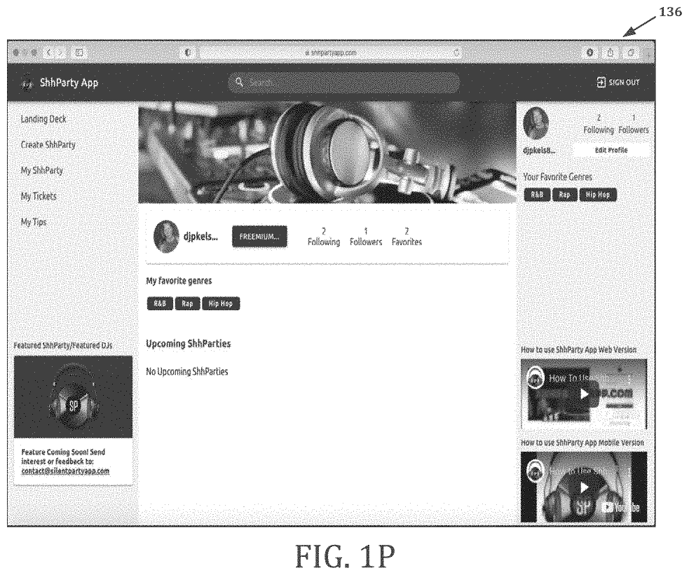

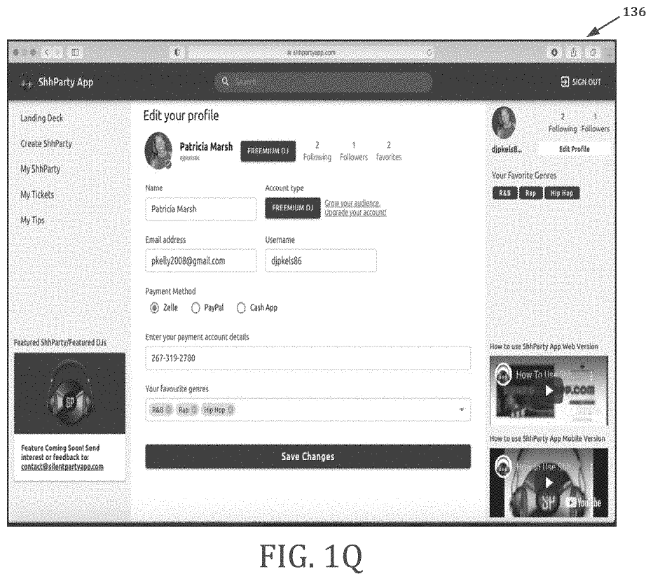

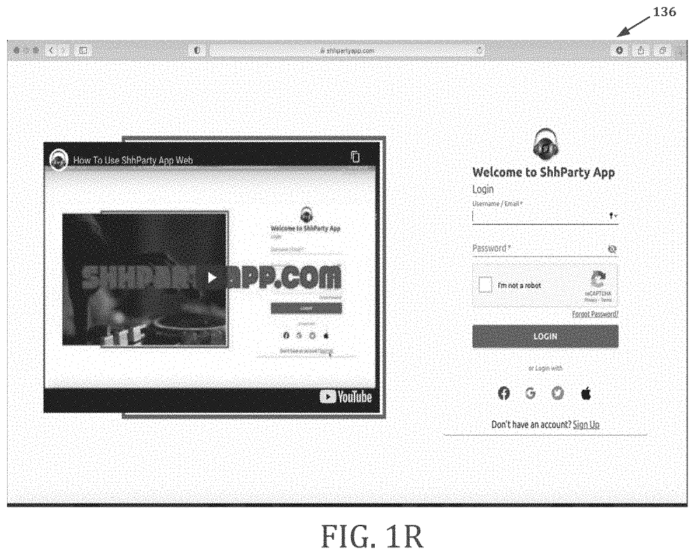

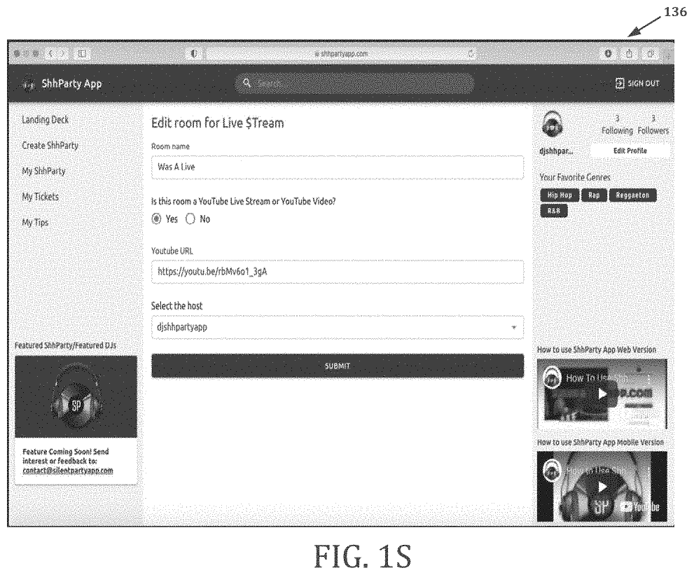

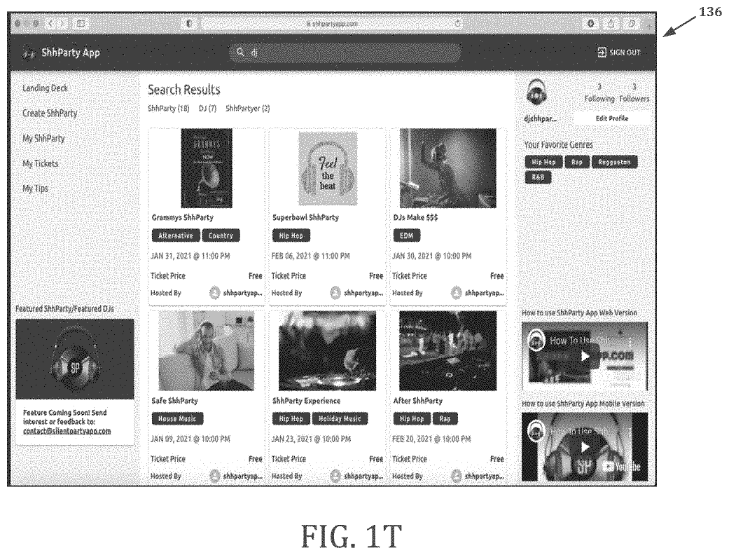

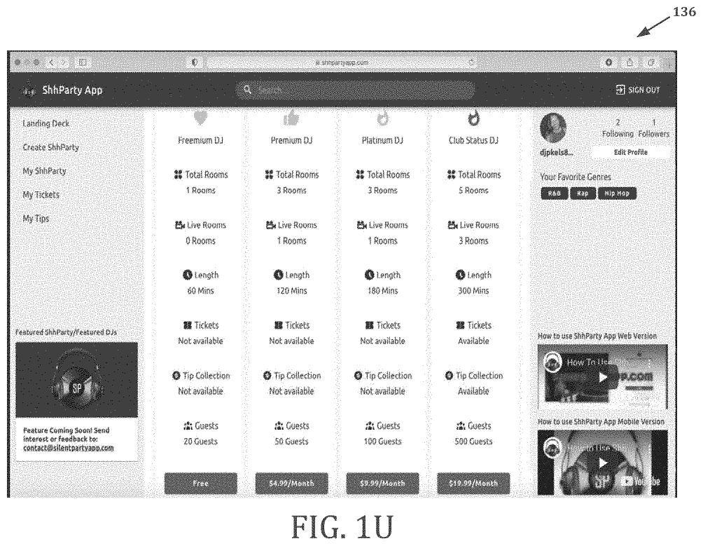

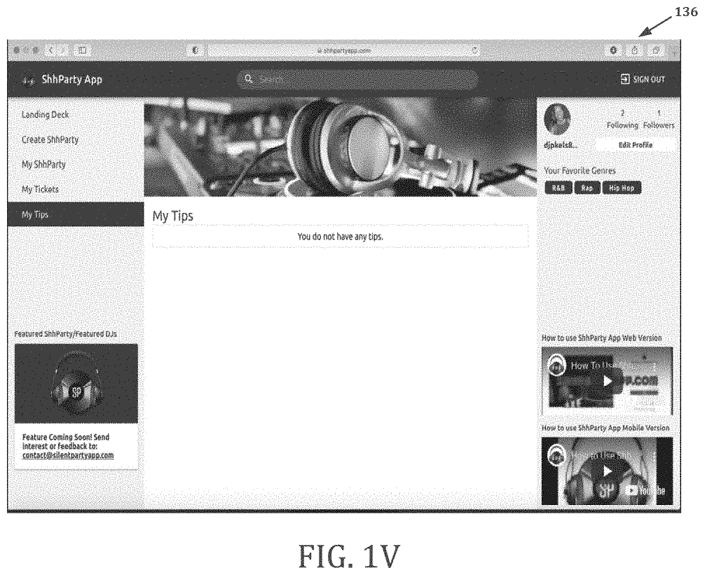

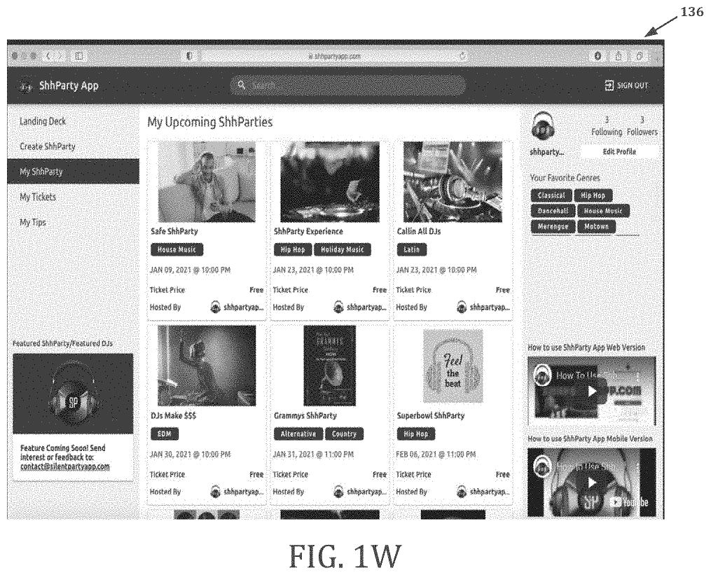

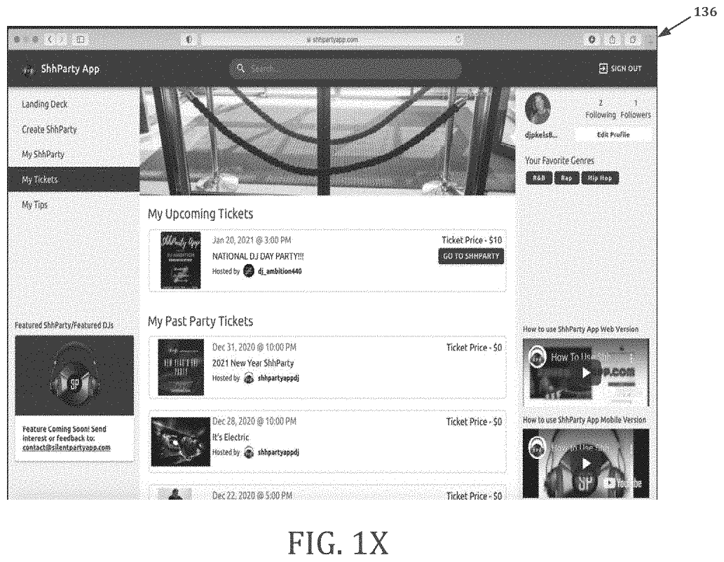

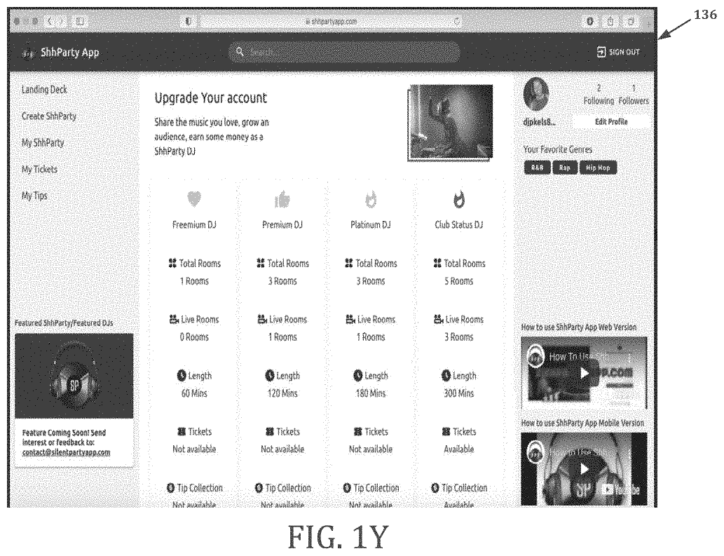

With reference now to the drawings, and in particular FIG. 1A through FIG. 4 thereof, examples of the real-time system and methods of hosting and streaming silent parties and the principles and concepts thereof will be described.

The system and techniques disclosed herein can be described as a software platform, including computer software applications (apps) and a backend system that can be used to provide hosting a silent party. The system allows a host to set up a silent party, specifically selecting the music that is played during the silent party and designating virtual “rooms” where different genres of music can be played simultaneously (catering to attendees having different musical tastes) during the silent party. Further, the system streams the real-time content, including music, for the silent party to different silent party attendees at various locations that can be remote from the host. The silent party attendees can access the audio stream, using their respective computer devices and headphones, so that the music can still be enjoyed “silently” and in real-time by all remote attendees simultaneously. Accordingly, the system allows for a unique and exciting “virtual” silent party experience that can be enjoyed by users anywhere in real-time, as if they were all physically together in the same room of a conventional (i.e., non-virtual, non-simulated, non-socially distanced, live and not remote, etc.) silent party. Consequently, the systems and methods disclosed herein continues to address the problem of noise pollution by hosting a silent party, while enhancing the event to be experienced remotely by many different attendees remotely in real-time. In some embodiment, the system allows a host of the silent party to set up three or more different musical “virtual” room experiences (where each room will have a different genre of music played) within the same silent party. Also, the silent party can be open to registered or unregistered silent party users (e.g., via the software application and via a website), and supporting secure access by requiring a code and/or password that party attendees will need to have access to the silent party experience.

In an embodiment, the real-time hosting and streaming for a silent party is tailored for a group running experience. For example, the system can provide playlists for virtual runs. According to this embodiment, organizations, such as 501c3 organizations can use a silent party raise to money whether their runners are running together as a collective or running individually in various remote locations.

In another embodiment, the real-time hosting and streaming for a silent party is tailored for a group fitness and/or exercise experience. According to this embodiment, the system can provide a silent party as a fitness experience via video and audio, such as a prepared playlist, for different types of fitness activities. According to this embodiment, this fitness experience of the silent party can have attendees that may experience the party together as collective or individually in various remote locations.

In another embodiment, the real-time hosting and streaming for a silent party is tailored for a book club and/or children's book experience. According to this embodiment, the system can provide a silent party as a “virtual” space for users to read together and discuss what was read as a collective, or individually in various remote locations, or even in person. As an example, users can listen to audiobooks, a “storytime” where a book is being read aloud by a reader, or the book itself being displayed allowing users to read it together and then discuss via video and/or written comments.

In another embodiment, the real-time hosting and streaming for a silent party is tailored for a study group experience. According to this embodiment, the system can provide a silent party as a “virtual” study group. For example, the silent party is an environment, or “virtual” room for a study group to meet up and study materials virtually while being in various remote locations, or in person.

In another embodiment, the real-time hosting and streaming for a silent party is tailored for a listening party and/or album release experience. According to this embodiment, the system can provide a silent party for users to hear new or exclusive music. For example, the silent party can include a newly released album in its playlist for users to listen to while being in various remote locations, or in person.

In another embodiment, the real-time hosting and streaming for a silent party is tailored for a studio recording experience. According to this embodiment, the system can provide a silent party as a “virtual” studio where artists can collaborate in person or virtually while being in remote locations. For example, the system can additionally provide recording software that connects users, and has mixing capabilities already built into the app. The system can also create a list of expert products that are best used to record when in conjunction with the system outside of recording a conventional studio.

In another embodiment, the real-time hosting and streaming for a silent party is tailored for a “virtual” concert experience. According to this embodiment, the system can support a worldwide silent party, much like a physical world tour, that can still be monetized for the performer. The performer can perform their music in a location that is remote from the attendees, while their performance is streamed in real-time to users in various remote locations simultaneously.

In another embodiment, the real-time hosting and streaming for a silent party is tailored for a video game experience. According to this embodiment, the system can provide a silent party as a unique gaming experience, where the object of the game is for the user to become a world-famous disc jockey (DJ). As an example, the gaming experience can provide silent parties for DJs to battle and recruit users to come to their silent parties and gain a following all through the game. The gaming experience can be used to teach aspiring DJs skills needed to become a world-famous DJ in a fun and entertaining manner.

In another embodiment, the real-time hosting and streaming for a silent party is tailored for a DJ battling experience. According to this embodiment, the system can provide a silent party for DJs who want to go head-to-head with other DJs. For example, a DJ can upload their original pieces as a playlist included in the silent party, and users can vote on said battles with virtual indications of likes. The system can also provide a means for DJs to redeem their likes into prizes or money, which allows the DJs to register to the system as a new source of income (especially in times of social distancing).

In another embodiment, the real-time hosting and streaming for a silent party is tailored for a virtual reality (VR) experience. According to this embodiment, the system can provide a silent party as a unique VR experience that can be experienced by multiple remote users simultaneously, no matter where they are located throughout the world. In some instances, the VR experience can be used with the above-mentioned concert feature, providing an enhanced concert experience where a user feels like they are attending the concert live thru VR.

In another embodiment, the real-time hosting and streaming for a silent party is tailored for a professional DJ experience. According to this embodiment, the system can support several aspects of a DJ software and ability to post new material, in order to create income. The system expands opportunities for professional DJs beyond physical gigs, by allowing a professional DJ to DJ a silent party on the system as virtual gigs. Furthermore, video content can be created using the system, which gives a professional DJ the ability to record themselves live in the creative process and share it, or share the finished product. Further, the DJ can host their own real-time silent party, and personally invite their friends to attend in order to promote themselves and gain experience.

In yet another embodiment, the real-time hosting and streaming for a silent party is tailored for a movie experience. According to this embodiment, the system can provide a silent party as a unique movie watching experience that allows multiple remote users to watch the same movie simultaneously as a shared experienced no matter where they are located throughout the world.

Referring now to FIG. 1A, an example of a communication environment 100 in which embodiments of the real-time hosting and streaming for silent party system 110, disclosed herein may be implemented. The real-time hosting and streaming for silent party system 110 provides various features that add automation, security, and increased access to aspects of silent parties that are not currently available.

The real-time hosting and streaming for silent party system 110 can be a network-based platform (e.g., Internet) that is accessed and interacted with in real-time by a plurality of distributed users. Thus, the system 110 allows a silent party experience to be hosted, for example by a DJ, where the music played by the host can be streamed in real-time as video and/or audio content. Thus, remote users can access a hosted silent party via the system 110, allowing the users to listen to and enjoy the music played in the silent party simultaneously while remaining in their respective locations, simulating a party where these users are physically in the same room. In the illustrated example, a host device 140, shown as a laptop, which may be owned and used by a DJ is connected to the real-time hosting and streaming for silent party system 110. Additionally, consumer devices 130a, 130n, shown as a laptop 130a with associated wireless headphones 130b and a smartphone 130c with associated earbuds 130d which may be owned and used by users that want to attend a silent party and listen to music by connecting to the real-time hosting and streaming for silent party system 110. It should be appreciated that the configuration in FIG. 1A serves as an example for purposes of discussion, and that any number of host devices and consumer devices may be connected to the real-time hosting and streaming for silent party system 110. Through the use of the real-time hosting and streaming for silent party system 110, the group of consumer devices 130a, 130b can simultaneously access and listen to a real-time stream of a silent party, as it being broadcasted live by the provider device 140. As alluded to above, silent parties typically involve attendees being in the same physical location, such as a room or club, in order to experience the party. Requiring an attendee's physical presence can restrict the amount of people that can enjoy the event (e.g., room capacity limits), or restricts when the event can occur (e.g., cancelled due to social distancing or other unforeseen circumstances), which in turn limits accessibility and visibility of the hosting DJ. However, the real-time hosting and streaming for silent party system 110 can be used by the DJ to stream the music being played as a silent party in real-time. Accordingly, a group of attendees can simultaneously and remotely experience the silent party, using their respective electronic computing devices, while in their respective locations (e.g., comfort of their own homes) in a manner that is otherwise difficult when they must be physically present.

The host device 140 and the consumer devices 130a, 130c can establish wireless connections to the real-time hosting and streaming for silent party system 110 via the communication network 120, such as the Internet. Thus, the real-time hosting and streaming for silent party system 110 can include a web-based platform that can be accessed remotely by a software application (app) installed on the device to control the creation, distribution, and security related to the streaming of real-time silent party. FIG. 1A shows that host device 140 can have a silent party host app 145 installed thereon. According to the embodiments, the silent party host app 145 supports the set-up of a silent party, and provides the real-time streaming of selected music to multiple consumers devices in a silent party. Additionally, FIG. 1A shows that consumer device 130a can have a silent party attendee app 135 installed thereon. According to the embodiments, the silent party attendee app 135 supports the user connecting to and outputting the real-time streaming of the silent party, for instance playing music thru the consumers device 130a and headphones 130b. In some cases, the silent party host app 145 and the silent party attendee app 145 can be downloaded in response to the users registering to the system 110. Alternatively, consumer device 130c is shown as not having the app installed thereon. Without the app, the consumer device 130c can access the system 110 and a streamed silent party by first connecting to a website on the Internet that provides a portal to the system 110. As referred to herein, real-time content of the silent party can be dynamically recorded and distributed digital video, visual data, audio data, and the like. For example, the host can select music (e.g., audio files) that serves as a playlist for the silent party.

The communication network 120 can support any number of wireless communication protocols such as: WIFI, BLUETOOTH, ZIGBEE, cellular based protocols, etc. In some implementations, communication network 120 may comprise a wired link. It should be appreciated that the host device 140 and the consumer devices 130a, 130c may be implemented as various numbers of computing devices, such as a smartphone, a tablet, a laptop, a workstation, a local or remote server, or a wearable device such as a smartwatch. Furthermore, the consumer devices 130a, 130c are connected to an audio output device that lets a single user listen to an audio source privately, in contrast to a loudspeaker (which emits sound into the open air for anyone nearby to hear), so that music of the silent party can be listened to “silently”. In the example, the consumer device 130a is wirelessly connected to headphones 130b, and the consumer device 130c has a wired connection to earbuds 130d. It should be appreciated that the audio output devices may be implemented as various devices, such as headphones, earbuds, air pods, and the like.

In some embodiments, the consumer devices 130a, 130b can be connected to an VR enabled output device that enables the user to be visually immersed in an VR/AR experience, such as a VR head mounted device, VR headset, VR goggles, is a heads-up display (HUD), Oculus™, and the like. In FIG. 1A, the VR enabled output device is shown as a VR headset 130e. Generally, a VR headset 130e is a head worn apparatus that completely covers the eyes to allows the user to interact with simulated environments and experience a first-person view (FPV). In some implementations, the VR headset 130e relies on the smartphone (e.g., smartphone inserted into the VR headset). In other implementations, the VR headset 130e may be entirely self-contained, providing the VR view without being connected to a smartphone or other computing device. Also, VR headset 130e can use some combination of accelerometer, gyroscope, magnetometer and proximity sensor to detect the user's motion.

By using the VR headset 130e with the functionality of the silent party attendee app 135, a natural environment such as a nightclub or a concert, can be replaced with virtual reality content including a 360-degree virtual reality (VR) or Augmented Reality (AR) environment that allows the user to turn and look around, just as in the physical world.

As referred to herein, VR and AR are an interactive experience of a real-world environment where the objects that reside in the real world are enhanced by computer-generated perceptual information, sometimes across multiple sensory modalities, including visual, auditory, haptic, somatosensory and olfactory. VR and AR can be a system that fulfills three basic features: a combination of real and virtual worlds, real-time interaction, and accurate 3D registration of virtual and real objects. The overlaid sensory information can be constructive (i.e., additive to the natural environment), or destructive (i.e., masking of the natural environment). This experience is seamlessly interwoven with the physical world such that it is perceived as an immersive aspect of the real environment. In this way, AR alters one's ongoing perception of a real-world environment, whereas VR can completely replace the user's real-world environment with a simulated one. That it, AR refers to computer-generated simulations that integrate the real world (e.g., AR) or are entirely self-contained (e.g., VR). AR applications let you move around in the real world.

According to this embodiment, the system can provide a silent party as a unique VR/AR experience that can be experienced by multiple remote users simultaneously, no matter where they are located throughout the world. In some instances, the VR experience can be used with the above-mentioned concert feature or to create a virtual nightclub (e.g., a VR experience shared with other users of the in the same virtual nightclub/room). Thus, the silent party attendee app 135 can provide an enhanced VR/AR experience, where a user feels like they are attending a live concert or in a night club listening to music with other people. In FIG. 1A, a user can wear the VR headset 130e to view a live feed of a concert that is actually taking place in a remote location. For example, a Beyonce performance at the Glastonbury Festival in Somerset, England can be streamed in real-time via the silent party attendee app 135 and simulated as a completely immersive 3D visual and audio experience for a user that is currently in Florida (USA) through the VR headset 130e.

Accordingly, the host device 140 and the consumer devices 130a, 130b can utilize software applications, namely the silent party host app 145 and the silent party attendee app 135 respectively, that implement a graphical user interfaces (GUI) and user experience (UX) environments of the real-time hosting and streaming for silent party system 110 to allow a user to access, view, and interact with real-time content as it is streamed over the distributed communication network 120 (e.g. Internet) and made locally available (e.g., local networks or individual computers and devices). Examples of GUIs that may be implemented by the silent party attendee app 135 that allow a user to interact with various features supported by the silent party system 110 are depicted in FIG. 1B—FIG. 1Y. It should be understood that the GUIs illustrated are merely exemplary and are not intended to be limiting. Accordingly, the silent party attendee app 135, as disclosed herein, can support other GUIs and/or features that are not illustrated in FIG. 1B-FIG. 1Y.

Although the system 110 is described as supporting real-time streaming over the Internet, it should be appreciated that the system 110 can also support various other forms of distributing video content, such as broadcasting over satellite networks, broadcasting over closed circuit tv networks, broadcasting over cellular networks, and the like.

The real-time hosting and streaming for silent party system 110 can be a backend computer system(s), such as a server, that implements functionality and features that support real-time hosting and streaming for a silent party. For example, the real-time hosting and streaming for silent party system 110 can receive registration information from the users of the host device 140 and the consumer devices 130a, 130c that are relevant to operation of the system, such as: properly identifying the users for login to the system 110; properly distributing streamed real-time content to particularly users; and verifying security credentials for access to streamed real-time content for particularly users. For example, a user of the host provider device 140 may be a DJ that registers to the system 110 and provides identification related information (e.g., name, age, music genres), and device and/or contact related information (e.g., email address, cell phone number, etc.). As another example, a user of the consumer device, such as device 130a, may be a party attendee that registers to the system 110 and provides identification related information (e.g., name, age, music genres), and device and/or contact related information (e.g., email address, cell phone number, etc.). Once the users are registered, users of the real-time hosting and streaming for silent party system 110 are allowed access to the functions and features of the system, such as hosting silent parties to be uploaded to the system 110 for streaming and accessing a streamed silent party in real-time from the system 110.

A characteristic of the real-time hosting and streaming for silent party system 110 is providing simultaneous and secure real-time streaming to the multiple consumer devices 130a, 130b of a silent party in real-time that are broadcasted by the content provider 140. In the illustrated example, prior to the live stream, the system 110 can distribute data for secure access to the real-time stream 150 to one or more of the consumer devices 130a, 130b.

The data 150 can include information that may be used to securely access the scheduled real-time stream of the upcoming silent party. For instance, the data 150 can include a unique identifier that is generated by the system 110 to access the particular real-time stream, such as a hypertext transfer protocol (HTTP) link. Also, the data 150 can include a uniquely generated security access code that is created by the system 110. In some cases, the security access code can correspond to the particular real-time stream, to a particular one of the consumer devices 130a-130n (or a combination of both), and must be entered by the recruiter via their consumer device 130a-130n (and successfully verified by the system 110) when attempting to access the real-time streaming content. Accordingly, the system 110 adds a layer of security to its capabilities, by restricting access to real-time streams only to consumer devices 130a, 130b that have the unique identifier and the unique security code for the real-time stream. In other words, the system 110 can deny access to any user attempting to access the real-time stream using its unique code and corresponding unique security access code. In some embodiments, the aforementioned security mechanisms can also be applied to the host when attempting to set-up a real-time stream for their silent party. The data 150 can be in the form of any electronic message that can be transmitted by the system 110 via the communication network 120, such as an email or a short message service (SMS) message.

As an example, a DJ can log-in to the system 110 using the host device 140. Once logged-in the DJ can record themselves playing music live, transmitting this video content from their host device 140 to the system 110 in order to be subsequently streamed in real-time to other devices that have remotely accessed the system 110 at that time. In another embodiment, the DJ can create a set-playlist of audio files that can be uploaded to the system 110, which is played in order in real-time. For instance, a DJ can set-up different virtual rooms for the silent party, where each room is intended to cater to attendees wanting to listen to a distinct genre of music. Accordingly, the DJ can use their host device to generate a set-playlist of country songs that can be designated for a first room, and a different set-playlist of pop songs that can be designated for a second room, and a different set-playlist of rap songs that can be designated for a third room. The system 110 can play these different playlists in each of the virtual rooms simultaneously, providing a simulated experience for users to selectively “enter” these rooms during the silent party that is similar to going into different rooms of a nightclub. Consumer devices 130a, 130c may be associated with party attendees that were invited by the DJ that is hosting the live event, and that have accessed the real-time stream of the silent party facilitated by the system 110 using their received data 150. Therefore, a large group of attendees can simultaneously and remotely “attend” the silent party, by viewing the real-time stream of the DJ distributed by the system 110. This type of large-scale attendance may otherwise not be possible if each of the attendees were required to physically attend their silent party.

According to the embodiments, the real-time hosting and streaming for silent party system 110 can store the real-time silent party content for later retrieval and/or download by the consumer devices 130a, 130b. For example, the DJ can record video content of playing music live. Thus, even if a silent party attendee is not able to access the system 110 during the time of the live silent party to view the real-time stream, the attendee can access the system 110 after the real-time stream has ended and play the video content that has been stored on the system 110. In some embodiments, the system 110 stores real-time streaming content for a certain time period (e.g., automatically determined by the system) after the event has ended. For example, the system 110 may store video content for 10 days to 30 days after the silent party (or real-time stream) has ended.

FIG. 1B illustrates an example GUI 136 displaying a mobile view of a live real-time silent party feature that may be implemented by the silent party attendee application shown in FIG. 1A. For example, the GUI 136 may be displayed on a screen of a handheld consumer device (e.g., smartphone).

FIG. 1C illustrates an example GUI 136 displaying a mobile view of an account upgrade feature that may be implemented by the silent party attendee application shown in FIG. 1A. For example, the GUI 136 may be displayed on a screen of a handheld consumer device (e.g., smartphone).

FIG. 1D illustrates an example GUI 136 displaying a mobile view of a profile data collection feature that may be implemented by the silent party attendee application shown in FIG. 1A. For example, the GUI 136 may be displayed on a screen of a handheld consumer device (e.g., smartphone).

FIG. 1E illustrates an example GUI 136 displaying a mobile view of a public profile feature that may be implemented by the silent party attendee application shown in FIG. 1A. For example, the GUI 136 may be displayed on a screen of a handheld consumer device (e.g., smartphone).

FIG. 1F illustrates an example GUI 136 displaying a mobile view of a landing deck feature that may be implemented by the silent party attendee application shown in FIG. 1A. For example, the GUI 136 may be displayed on a screen of a handheld consumer device (e.g., smartphone).

FIG. 1G illustrates an example GUI 136 displaying a mobile view of a ticket feature that may be implemented by the silent party attendee application shown in FIG. 1A. For example, the GUI 136 may be displayed on a screen of a handheld consumer device (e.g., smartphone).

FIG. 1H illustrates an example GUI 136 displaying a mobile view of a real-time silent party details feature that may be implemented by the silent party attendee application shown in FIG. 1A. For example, the GUI 136 may be displayed on a screen of a handheld consumer device (e.g., smartphone).

FIG. 1I illustrates an example graphical user interface displaying a web view of an archive of real-time silent parties feature that may be implemented by the silent party attendee application shown in FIG. 1A, according to one or more embodiments shown and described herein. For example, the GUI 136 may be displayed on a screen of a mobile consumer device (e.g., laptop).

FIG. 1J illustrates an example graphical user interface displaying a mobile view of a search feature that may be implemented by the silent party attendee application shown in FIG. 1A, according to one or more embodiments shown and described herein. For example, the GUI 136 may be displayed on a screen of a handheld consumer device (e.g., smartphone).

FIG. 1K illustrates an example graphical user interface displaying a mobile view of a create a ShhParty feature that may be implemented by the silent party attendee application shown in FIG. 1A, according to one or more embodiments shown and described herein. For example, the GUI 136 may be displayed on a screen of a handheld consumer device (e.g., smartphone).

FIG. 1L illustrates an example GUI 136 displaying a mobile view of a registration/login feature that may be implemented by the silent party attendee application shown in FIG. 1A. For example, the GUI 136 may be displayed on a screen of a handheld consumer device (e.g., smartphone).

FIG. 1M illustrates an example GUI 136 displaying a web view of a landing deck feature that may be implemented by the silent party attendee application shown in FIG. 1A. For example, the GUI 136 may be displayed on a screen of a mobile consumer device (e.g., laptop).

FIG. 1N illustrates an example GUI 136 displaying a web view of an edit room feature that may be implemented by the silent party attendee application shown in FIG. 1A. For example, the GUI 136 may be displayed on a screen of a mobile consumer device (e.g., laptop).

FIG. 1O illustrates an example GUI 136 displaying a web view of a past tickets feature that may be implemented by the silent party attendee application shown in FIG. 1A. For example, the GUI 136 may be displayed on a screen of a mobile consumer device (e.g., laptop).

FIG. 1P illustrates an example GUI displaying a web view of a public profile feature that may be implemented by the silent party attendee application shown in FIG. 1A. For example, the GUI 136 may be displayed on a screen of a mobile consumer device (e.g., laptop).

FIG. 1Q illustrates an example GUI displaying a web view of a profile data collected feature that may be implemented by the silent party attendee application shown in FIG. 1A. For example, the GUI 136 may be displayed on a screen of a mobile consumer device (e.g., laptop).

FIG. 1R illustrates an example GUI displaying a web view of a registration/login feature that may be implemented by the silent party attendee application shown in FIG. 1A. For example, the GUI 136 may be displayed on a screen of a mobile consumer device (e.g., laptop).

FIG. 1S illustrates an example GUI displaying web view of a real-time silent party room details feature that may be implemented by the silent party attendee application shown in FIG. 1A. For example, the GUI 136 may be displayed on a screen of a mobile consumer device (e.g., laptop).

FIG. 1T illustrates an example GUI 136 displaying a web view of a search feature that may be implemented by the silent party attendee application shown in FIG. 1A. For example, the GUI 136 may be displayed on a screen of a mobile consumer device (e.g., laptop).

FIG. 1U illustrates an example GUI 136 displaying a web view of a subscription account feature that may be implemented by the silent party attendee application shown in FIG. 1A. For example, the GUI 136 may be displayed on a screen of a mobile consumer device (e.g., laptop).

FIG. 1V illustrates an example GUI 136 displaying a web view of a subscription account types feature that may be implemented by the silent party attendee application shown in FIG. 1A. For example, the GUI 136 may be displayed on a screen of a mobile consumer device (e.g., laptop).

FIG. 1W illustrates an example GUI 136 displaying a web view of an upcoming real-time silent party feature that may be implemented by the silent party attendee application shown in FIG. 1A. For example, the GUI 136 may be displayed on a screen of a mobile consumer device (e.g., laptop).

FIG. 1X illustrates an example GUI 136 displaying a web view of an upcoming tickets feature that may be implemented by the silent party attendee application shown in FIG. 1A. For example, the GUI 136 may be displayed on a screen of a mobile consumer device (e.g., laptop).

FIG. 1Y illustrates an example GUI 136 displaying a web view of an upgrade account feature that may be implemented by the silent party attendee application shown in FIG. 1A. For example, the GUI 136 may be displayed on a screen of a mobile consumer device (e.g., laptop).

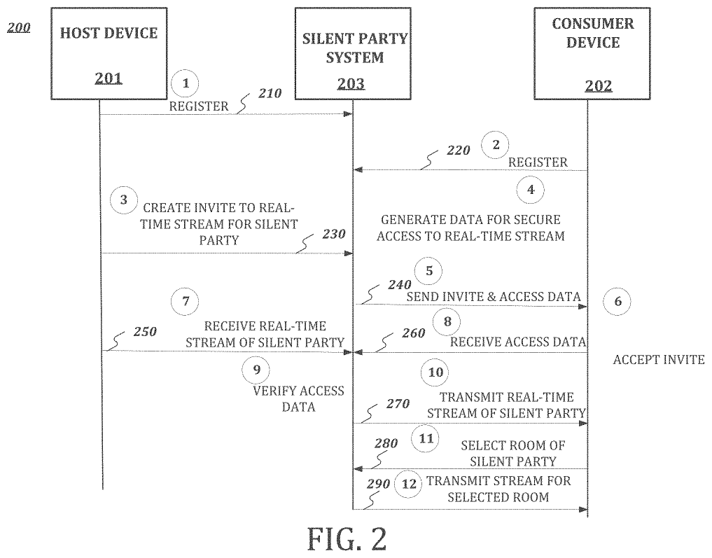

Referring now to FIG. 2, an example of a message flow 200 between a host device 201 (e.g., silent party host), a consumer device 202 (e.g., silent party attendee), and the real-time hosting and streaming for silent party system 203. The message flow 200 can be related to conducting a real-time hosting and streaming for a silent party via the system 203, in accordance with an exemplary embodiment of the present disclosure. Initially, the system 203 can receive registration data from the host device 201 at flow 210, and registration data from the consumer device 202 at flow 220 which allow associated users, such as a DJs and party goers to register with the system 203. After the system 203 has received the registration information in flows 210 and 220, it can be assumed that the system 203 has the information necessary to identify and stream content to the users.

Next, a silent party host can generate, via their host device 201, an invitation to view a real-time stream of an upcoming silent party. Once generated, the host device 201 can transmit this invitation to the system 203 in flow 230 to be further distributed to attendees of the silent party, such as consumer device 202. In some cases, the host can directly select invitees that are to receive the generated invitation to the real-time stream, such as registered users having an interest in the music that they play. Alternatively, the system 203 can generate a list of invitees based on matching (or filtering) attendees to criteria using based on their data, such as age and music genres of interest.

Once the system 203 has an awareness of an upcoming silent party to be hosted by a DJ as a real-time stream (based on receiving their generated invitation in flow 230), the system 203 can generate the data used for secure access to the upcoming real-time stream of the silent party. As previously described, this data can include an HTTP link that uniquely corresponds to the upcoming live event for the athlete, and a security access code and/or password(s) that may uniquely correspond to an individual recruiter that is being invited to access the real-time stream. Subsequently, the system 203 can distribute the invitation and the data for securely accessing the real-time stream (e.g., HTTP link, and security access code) specifically to devices of the invited attendees, such as consumer device 202. As alluded to above, this data that is communicated in flow 240 is required in order to access the real-time stream via the system 203. For example, without the proper HTTP link and/or security access code, the system 203 can deny an attempt to access the real-time streaming. By the system 203 regulating which users are invited to (and subsequently have access to) certain real-time streams, the athlete can host a by “invitation only” scouting event that can be viewed simultaneously by many different recruiters remotely via the system 203.

In some cases, the attendee can accept the invitation after it is received in flow 240. The invitation can be sent to the consumer device 202 as an electronic message, such as an email or SMS message, a social media post that includes a link to the invitation, and the like. As an example, the host can select an RSVP option in the message via their consumer device 202 to accept the invitation. This allows the host to receive some notification regarding which attendees are planning to virtually attend their hosted event via the real-time stream.

Next, at flow 250, the system 203 can start to receive video content from the host device 201 that is being recorded in real-time at the start of the silent part. For instance, once a silent party has started, the DJ can begin playing music live and select a “start live stream” option on the platform via their host device 201, which signals to the system 203 to prepare receive the video stream, and to inform the attendees that the real-time stream has begun for them to access and view. In response to initiating the real-time stream of the silent party, the system 203 then allows the consumer device 202 to submit the data to access the real-time stream in flow 260, now that it has begun. The system 203 then verifies the data received in flow 260 to before transmitting the real-time stream to the consumer device 202. As an example, the system 203 determines whether the HTTP link is correct (corresponds to the event in the invitation) and determines whether the security access code is valid (corresponds to the user) prior to enabling the consumer device 201 to receive the real-time stream of the silent party. Once the attendee has been successfully verified by the system 203, the real-time stream of the silent party is transmitted to the consumer device 202 to be viewed as the event is occurring. Thus, the system 203 broadcasts a live stream that can be a simulated silent party.

Subsequently, once the attendee has accessed the silent party, they can begin to access other features associated with their party experience. For example, the attendee can select a specific “virtual” room of the silent party to enter in flow 280. As an example, a silent party can initially display several small widows on the consumer device 202 corresponding to each room, showing the attendee a preview of the type of music and experience associated with that room. Each room can have a different visual and audio feel, such that users have a range of experiences within a silent party. Subsequently, after a room is selected, the system 203 can transmit the real-time stream corresponding to that room of the silent party to the consumer device 202 in flow 290.

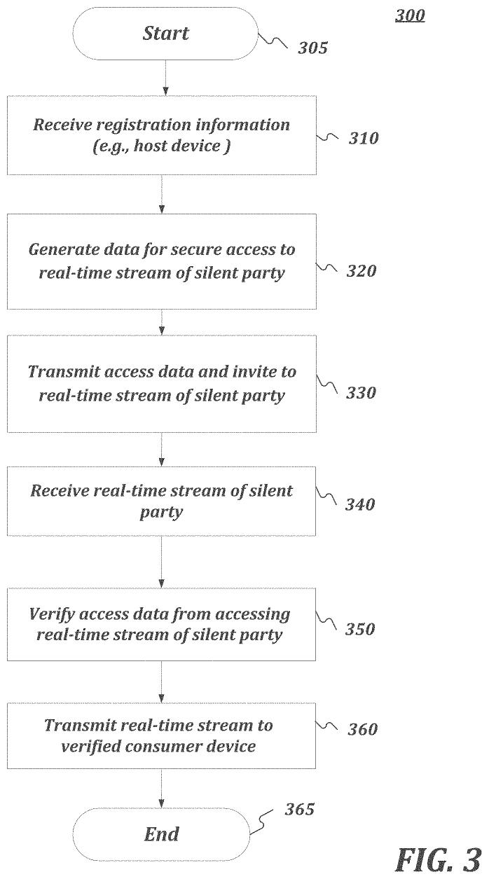

Referring now to FIG. 3, an example of a method 300 for implementing the real-time hosting and streaming for one or more silent party techniques is shown. The method 300 can be related to conducting a real-time silent party via a system (shown in FIG. 1A). The process start can be considered operation 305.

Then, the process 300 moves to operation 310, where the system receives registration data from a host device and registration data from a consumer device. This registration can allow associated users, such as DJs and party goers to register with the system.

Next, at operation 320, the system can generate data for secure access to a real-time stream of the silent party. In some cases, operation 320 is performed in response to the system receiving an invite, created by a host (e.g., host device), to view a real-time steam of the silent party. For instance, after the system has an awareness of an upcoming silent party to be hosted as a real-time stream, the system can perform operation 320. Operation 320 can include the system generating an HTTP link that uniquely corresponds to the upcoming live event for a silent party, and a security access code and/or password that may uniquely correspond to an individual party attendee that is being invited to access the real-time stream of the silent party.

Subsequently, at operation 330, the system can transmit the invite and the data for securely accessing the real-time stream (e.g., HTTP link, and security access code) specifically to devices of the invited silent party attendees, such as consumer devices. As alluded to above, this data that is communicated in operation 330 is required in order to access the real-time stream via the system. In some embodiments, the invitation can be sent in operation 330 as an electronic message, such as an email or SMS message.

Continuing to operation 340, the system can start to receive video content from the host device that is being recorded in real-time at the start of the silent party. This effectively starts the real-time stream, as the video is transmitted to the system. Alternatively, operation 340, can involve the host device uploading a set playlist to the system to start the silent party.

In response to initiating the real-time stream of the silent party, the method can proceed to operation 350. At operation 350, the system can receive a party attendee's data to access the real-time stream and verify this data. For instance, before transmitting the real-time stream to a consumer device, the system determines whether the HTTP link is correct (corresponds to the event in the invitation) and determines whether the security access code and/or password is valid (corresponds to the user) in operation 350.

Once a silent party attendee has been successfully verified by system, the process 300 goes to operation 360. At operation 360, the real-time stream of the silent party is transmitted to the consumer device, which has verified access, to be viewed as the event is occurring. Thus, the method 300 accomplishes broadcasting of a live stream that can be a simulated silent party that can be viewed remotely and simultaneously by multiple party attendees. The process 300 ends at operation 375.

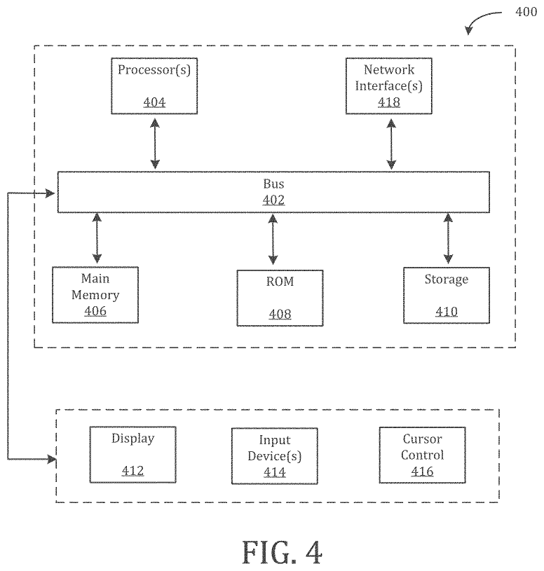

FIG. 4 depicts a block diagram of an example computer system 400 in which the disclosed aspects of the real-time hosting and streaming for silent party system (shown in FIG. 1A) may be implemented. Furthermore, it should be appreciated that although the various instructions are illustrated as being co-located within a single processing unit, there may be some implementations in which processor(s) includes multiple processing units, allowing one or more instructions may be executed remotely from the other instructions.

The computer system 400 includes a bus 402 or other communication mechanism for communicating information, one or more hardware processors 404 coupled with bus 512 for processing information. Hardware processor(s) 404 may be, for example, one or more general purpose microprocessors.

The computer system 400 also includes a main memory 406, such as a random-access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

The computer system 400 further includes a read only memory (ROM) 408 or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions.

The computer system 400 may be coupled via bus 402 to a display 412, such as a liquid crystal display (LCD) (or touch screen), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Python, Ruby on Rails or NodeJS. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor(s) 404 executing one or more sequences of one or more instructions contained in main memory 406. Such instructions may be read into main memory 706 from another storage medium, such as storage device 410. Execution of the sequences of instructions contained in main memory 406 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

The computer system 400 also includes a communication interface 418 coupled to bus 402. Network interface 418 provides a two-way data communication coupling to one or more network links that are connected to one or more local networks. For example, communication interface 418 may be an integrated services digital network (ISDN) card, cable modem, satellite modem, or a modem to provide a data communication connection to a corresponding type of telephone line. As another example, network interface 418 may be a local area network (LAN) card to provide a data communication connection to a compatible LAN (or WAN component to communicate with a WAN). Wireless links may also be implemented. In any such implementation, network interface 418 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local networks and Internet both use electrical, electromagnetic or optical signals that carry digital data streams. The signals through the various networks and the signals on network link and through communication interface 518, which carry the digital data to and from computer system 710, are example forms of transmission media.

The computer system 400 can send messages and receive data, including program code, through the network(s), network link and communication interface 418. In the Internet example, a server might transmit a requested code for an application program through the Internet, the ISP, the local network and the communication interface 418.

The received code may be executed by processor 404 as it is received, and/or stored in storage device 410, or other non-volatile storage for later execution.

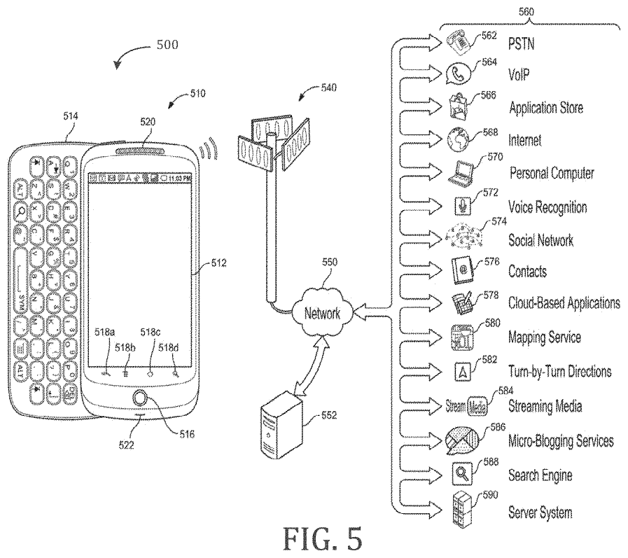

Referring now to FIG. 5, a conceptual diagram of a system 500 that may be used to implement the systems and methods described in this document is illustrated. In the system 500, a mobile (or handheld) computing device 510, such as a smartphone, that can execute the silent party attendee app is shown. The mobile computing device 510 can wirelessly communicate with base station 540, which can provide the mobile computing device wireless access to numerous hosted services 560 through a network 550.

As alluded to above, the mobile computing device 510 is depicted as a handheld consumer device (e.g., a smartphone, or an application telephone) that includes a touchscreen display device 512 for presenting content to a user of the mobile computing device 510 and receiving touch-based user inputs. Other visual, tactile, and auditory output components may also be provided (e.g., LED lights, a vibrating mechanism for tactile output, or a speaker for providing tonal, voice-generated, or recorded output), as may various different input components (e.g., keyboard 514, physical buttons, trackballs, accelerometers, gyroscopes, and magnetometers).

Example visual output mechanism in the form of display device 512 may take the form of a display with resistive or capacitive touch capabilities. The display device may be for displaying video, graphics, images, and text, and for coordinating user touch input locations with the location of displayed information so that the device 510 can associate user contact at a location of a displayed item with the item. The mobile computing device 510 may also take alternative forms, including as a laptop computer, a tablet or slate computer, a personal digital assistant, an embedded system (e.g., a car navigation system), a desktop personal computer, or a computerized workstation.

An example mechanism for receiving user-input includes keyboard 514, which may be a full qwerty keyboard or a traditional keypad that includes keys for the digits ‘0-9’, ‘*’, and ‘#.’ The keyboard 514 receives input when a user physically contacts or depresses a keyboard key. User manipulation of a trackball 516 or interaction with a track pad enables the user to supply directional and rate of movement information to the mobile computing device 510 (e.g., to manipulate a position of a cursor on the display device 512).

The mobile computing device 510 may be able to determine a position of physical contact with the touchscreen display device 512 (e.g., a position of contact by a finger or a stylus). Using the touchscreen 512, various “virtual” input mechanisms may be produced, where a user interacts with a graphical user interface element depicted on the touchscreen 512 by contacting the graphical user interface element. An example of a “virtual” input mechanism is a “software keyboard,” where a keyboard is displayed on the touchscreen and a user selects keys by pressing a region of the touchscreen 512 that corresponds to each key.

The mobile computing device 510 may include mechanical or touch sensitive buttons 518 a-d. Additionally, the mobile computing device may include buttons for adjusting volume output by the one or more speakers 520, and a button for turning the mobile computing device on or off. A microphone 522 allows the mobile computing device 510 to convert audible sounds into an electrical signal that may be digitally encoded and stored in computer-readable memory or transmitted to another computing device. The mobile computing device 510 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. Example operating systems include ANDROID, CHROME, IOS, MAC OS X, WINDOWS 7, WINDOWS PHONE 7, SYMBIAN, BLACKBERRY, WEBOS—a variety of UNIX operating systems, or a proprietary operating system for computerized devices. The operating system may provide a platform for the execution of application programs that facilitate interaction between the computing device and a user.

The mobile computing device 510 may present a graphical user interface with the touchscreen 512. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. In some examples, selectable graphical interface elements further or alternatively correspond to a button on the keyboard 504. User-selection of the button may invoke the pre-defined action.

In some examples, the operating system provides a “desktop” graphical user interface that is displayed after turning on the mobile computing device 510, after activating the mobile computing device 510 from a sleep state, after “unlocking” the mobile computing device 510, or after receiving user-selection of the “home” button 518 c. The desktop graphical user interface may display several graphical interface elements that, when selected, invoke corresponding application programs. An invoked application program may present a graphical interface that replaces the desktop graphical user interface until the application program terminates or is hidden from view.

User-input may influence an executing sequence of mobile computing device 510 operations. For example, a single-action user input (e.g., a single tap of the touchscreen, swipe across the touchscreen, contact with a button, or combination of these occurring at a same time) may invoke an operation that changes a display of the user interface. Without the user-input, the user interface may not have changed at a particular time. For example, a multi-touch user input with the touchscreen 512 may invoke a mapping application to “zoom-in” on a location, even though the mapping application may have by default zoomed-in after several seconds.

The desktop graphical interface can also display “widgets.” A widget is one or more graphical interface elements that are associated with an application program that is executing, and that display on the desktop content controlled by the executing application program. A widget's application program may launch as the mobile device turns on. Further, a widget may not take focus of the full display. Instead, a widget may only “own” a small portion of the desktop, displaying content and receiving touchscreen user-input within the portion of the desktop.

The mobile computing device 510 may include one or more location-identification mechanisms. A location-identification mechanism may include a collection of hardware and software that provides the operating system and application programs an estimate of the mobile device's geographical position. A location-identification mechanism may employ satellite-based positioning techniques, base station transmitting antenna identification, multiple base station triangulation, internet access point IP location determinations, inferential identification of a user's position based on search engine queries, and user-supplied identification of location (e.g., by receiving user a “check in” to a location).

The mobile computing device 510 may include other applications, computing sub-systems, and hardware. A call handling unit may receive an indication of an incoming telephone call and provide a user the capability to answer the incoming telephone call. A media player may allow a user to listen to music or play movies that are stored in local memory of the mobile computing device 510.

The mobile device 510 may include a digital camera sensor, and corresponding image and video capture and editing software. An internet browser may enable the user to view content from a web page by typing in an address corresponding to the web page or selecting a link to the web page.

The mobile computing device 510 may include an antenna to wirelessly communicate information with the base station 540. The base station 540 may be one of many base stations in a collection of base stations (e.g., a mobile telephone cellular network) that enables the mobile computing device 510 to maintain communication with a network 550 as the mobile computing device is geographically moved. The computing device 510 may alternatively or additionally communicate with the network 550 through a Wi-Fi router or a wired connection (e.g., ETHERNET, USB, or FIREWIRE). The computing device 510 may also wirelessly communicate with other computing devices using BLUETOOTH protocols, or may employ an ad-hoc wireless network.

A service provider that operates the network of base stations may connect the mobile computing device 510 to the network 550 to enable communication between the mobile computing device 510 and other computing systems that provide services 560. Although the services 560 may be provided over different networks (e.g., the service provider's internal network, the Public Switched Telephone Network, and the Internet), network 550 is illustrated as a single network. The service provider may operate a server system 552 that routes information packets and voice data between the mobile computing device 510 and computing systems associated with the services 560.

The network 550 may connect the mobile computing device 510 to the Public Switched Telephone Network (PSTN) 562 in order to establish voice or fax communication between the mobile computing device 510 and another computing device. For example, the service provider server system 552 may receive an indication from the PSTN 562 of an incoming call for the mobile computing device 510. Conversely, the mobile computing device 510 may send a communication to the service provider server system 552 initiating a telephone call using a telephone number that is associated with a device accessible through the PSTN 562.

The network 550 may connect the mobile computing device 510 with a Voice over Internet Protocol (VoIP) service 564 that routes voice communications over an IP network, as opposed to the PSTN. For example, a user of the mobile computing device 510 may invoke a VoIP application and initiate a call using the program. The service provider server system 552 may forward voice data from the call to a VoIP service, which may route the call over the internet to a corresponding computing device, potentially using the PSTN for a final leg of the connection.

An application store 566 may provide a user of the mobile computing device 510 the ability to browse a list of remotely stored application programs that the user may download over the network 550 and install on the mobile computing device 510. The application store 566 may serve as a repository of applications developed by third-party application developers. An application program that is installed on the mobile computing device 510 may be able to communicate over the network 550 with server systems that are designated for the application program. For example, a VoIP application program may be downloaded from the Application Store 566, enabling the user to communicate with the VoIP service 564.

The mobile computing device 510 may access content on the internet 568 through network 550. For example, a user of the mobile computing device 510 may invoke a web browser application that requests data from remote computing devices that are accessible at designated universal resource locations. In various examples, some of the services 560 are accessible over the internet.

The mobile computing device may communicate with a personal computer 570. For example, the personal computer 570 may be the home computer for a user of the mobile computing device 510. Thus, the user may be able to stream media from his personal computer 570. The user may also view the file structure of his personal computer 570 and transmit selected documents between the computerized devices.

A voice recognition service 572 may receive voice communication data recorded with the mobile computing device's microphone 522 and translate the voice communication into corresponding textual data. In some examples, the translated text is provided to a search engine as a web query, and responsive search engine search results are transmitted to the mobile computing device 510.

The mobile computing device 510 may communicate with a social network 574. The social network may include numerous members, some of which have agreed to be related as acquaintances. Application programs on the mobile computing device 510 may access the social network 574 to retrieve information based on the acquaintances of the user of the mobile computing device. For example, an “address book” application program may retrieve telephone numbers for the user's acquaintances. In various examples, content may be delivered to the mobile computing device 510 based on social network distances from the user to other members in a social network graph of members and connecting relationships. For example, advertisement and news article content may be selected for the user based on a level of interaction with such content by members that are “close” to the user (e.g., members that are “friends” or “friends of friends”).

The mobile computing device 510 may access a personal set of contacts 576 through network 550. Each contact may identify an individual and include information about that individual (e.g., a phone number, an email address, and a birthday). Because the set of contacts is hosted remotely to the mobile computing device 510, the user may access and maintain the contacts 576 across several devices as a common set of contacts.

The mobile computing device 510 may access cloud-based application programs 578. Cloud-computing provides application programs (e.g., a word processor or an email program) that are hosted remotely from the mobile computing device 510 and may be accessed by the device 510 using a web browser or a dedicated program. Example cloud-based application programs include GOOGLE DOCS word processor and spreadsheet service, GOOGLE GMAIL webmail service, and PICASA picture manager.

Mapping service 580 can provide the mobile computing device 510 with street maps, route planning information, and satellite images. An example mapping service is GOOGLE MAPS. The mapping service 580 may also receive queries and return location-specific results. For example, the mobile computing device 510 may send an estimated location of the mobile computing device and a user-entered query for “pizza places” to the mapping service 580. The mapping service 580 may return a street map with “markers” superimposed on the map that identify geographical locations of nearby “pizza places.”

Turn-by-turn service 582 may provide the mobile computing device 510 with turn-by-turn directions to a user-supplied destination. For example, the turn-by-turn service 582 may stream to device 510 a street-level view of an estimated location of the device, along with data for providing audio commands and superimposing arrows that direct a user of the device 510 to the destination.

Various forms of streaming media 584 may be requested by the mobile computing device 510. For example, computing device 510 may request a stream for a pre-recorded video file, a live television program, or a live radio program. Example services that provide streaming media include YOUTUBE and PANDORA.

A micro-blogging service 586 may receive from the mobile computing device 510 a user-input post that does not identify recipients of the post. The micro-blogging service 586 may disseminate the post to other members of the micro-blogging service 586 that agreed to subscribe to the user.

A search engine 588 may receive user-entered textual or verbal queries from the mobile computing device 510, determine a set of internet-accessible documents that are responsive to the query, and provide to the device 510 information to display a list of search results for the responsive documents. In examples where a verbal query is received, the voice recognition service 572 may translate the received audio into a textual query that is sent to the search engine.

These and other services may be implemented in a server system 590. A server system may be a combination of hardware and software that provides a service or a set of services. For example, a set of physically separate and networked computerized devices may operate together as a logical server system unit to handle the operations necessary to offer a service to hundreds of computing devices. A server system is also referred to herein as a computing system.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device but may not include the second device receiving the data. Conversely, “receiving” from a first device may include receiving the data from a network but may not include the first device transmitting the data.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system, comprising:
a communication network;
a host device coupled to the communication network, wherein the host device comprises a software application enabling a setup of a silent party to provide a real-time stream of music to multiple remotely located attendees;
a plurality of consumer devices coupled the communication network, wherein the plurality of consumer devices is associated with at least one of the multiple remotely located attendees and the plurality of consumer devices comprises a software application to access the silent party to receive the real-time stream of music to multiple remotely located attendees.

2. The system of claim 1, wherein the host device uploads the real-time stream of music for the silent party.

3. The system of claim 2, further comprising:
a real-time hosting and streaming for silent party system coupled to the communication network, wherein the real-time hosting and streaming for silent party system receives the uploaded real-time stream of music for the silent party, and provides the real-time stream of music for the silent party to the plurality of consumer devices associated with multiple remotely located attendees.

4. The system of claim 3, wherein the real-time hosting and streaming for silent party system simultaneously provides the real-time stream of music for the silent party to the plurality of consumer devices for the multiple remotely located attendees to listen to the music simultaneously to simulate a physical silent party.

5. The system of claim 4, wherein the consumer devices correspond to an audio output device enabling the multiple remotely located attendees to listen to the real-time stream of music for the silent party privately.

6. The system of claim 5, wherein the audio output device comprises at least one of: headphones, earbuds, and air pods.

7. The system of claim 3, wherein the real-time hosting and streaming for silent party system:
registers the host device to the system enabling the host device to upload the real-time stream of music for the silent party via the software application; and
registers the plurality of consumer devices enabling the plurality of consumer devices to access the real-time stream of music for the silent party via the software application.

8. The system of claim 7, wherein the real-time hosting and streaming for silent party system:
communicates data for secure access to the real-time stream of music for the silent party to the plurality of consumer devices.

9. The system of claim 8, wherein the data for secure access to the real-time stream of music for the silent party is communicated to the plurality consumer devices via an email and a short message service (SMS)message.

10. The system of claim 9, wherein the real-time hosting and streaming for silent party system:
provides multiple rooms in the silent party, wherein the multiple rooms provides a real-time stream of a corresponding genre of music for the respective room.

11. The system of claim 10, wherein the software application enables the plurality of consumer devices to access the multiple rooms in the silent party to play the real-time stream of the corresponding genre of music for a respective room.

12. The system of claim 11, wherein the real-time hosting and streaming for silent party system:
stores the real-time stream of music for the silent party for retrieval by the plurality of consumer devices subsequent to ending the real-time stream of music for the silent party.

13. The system of claim 12, wherein the data for secure access to the real-time stream of music for the silent party comprises at least one of: a link, a code, and a password.

14. The system of claim 13, wherein the real-time hosting and streaming for silent party system provides access to the real-time stream of music for the silent party comprises in response to receiving the data from the plurality of consumer devices.

15. The system of claim 14, wherein the real-time hosting and streaming for silent party system provides access to the real-time stream of music for the silent party for an unregistered consumer device via a website.

16. A method for real-time hosting and streaming for a silent party, comprising:
receiving registration data associated with a host device, wherein the host device is enabled to set-up a silent party to provide a real-time stream of music to multiple remotely located attendees;
receiving registration data associated with a plurality of consumer devices, wherein the plurality of consumer devices is associated with at least one of the multiple remotely located attendees the plurality of consumer devices is enabled to access the silent party to receive the real-time stream of music to multiple remotely located attendees;
receiving the real-time stream of music for the silent party uploaded from the host device; and
upon receiving the real-time stream of music for the silent party uploaded from the host, transmitting the real-time stream of music for the silent party to the registered plurality of consumer devices.

17. The method of claim 16, wherein transmitting the real-time stream of music for the silent party to the plurality of consumer devices associated with multiple remotely located attendees is performed simultaneously such that the multiple remotely located attendees listen to the real-time stream of music for the silent party simultaneously to simulate a physical silent party.

18. The method of claim 16, further comprising:
generating data for secure access to the real-time stream of music for the silent party; and
transmitting the data and an invitation to the real-time stream of music for the silent party to the registered plurality of consumer devices.

19. A non-transitory computer-readable storage medium storing a plurality of instructions executable by one or more processors, the plurality of instructions when executed by the one or more processors cause the one or more processors to:
receive registration data associated with a host device, wherein the host device is enabled to set-up a silent party to provide a real-time stream of music to multiple remotely located attendees;
receive registration data associated with a plurality of consumer devices, wherein the plurality of consumer devices is associated with at least one of the multiple remotely located attendees the plurality of consumer devices is enabled to access the silent party to receive the real-time stream of music to multiple remotely located attendees;
receive the real-time stream of music for the silent party uploaded from the host device; and
upon receiving the real-time stream of music for the silent party uploaded from the host, transmit the real-time stream of music for the silent party to the registered plurality of consumer devices.

20. The computer-readable storage medium of claim 19, wherein transmitting the real-time stream of music for the silent party to the plurality of consumer devices associated with multiple remotely located attendees is performed simultaneously such that the multiple remotely located attendees listen to the real-time stream of music for the silent party simultaneously to simulate a physical silent party.
